(19) United States
(12) Patent Application Publication
(10) Pub. No.: US 2026/0176389 A1
(43) Pub. Date: Jun. 25, 2026

(54) COMPOSITION AND POLYMER

(71) Applicant: TOKYO OHKA KOGYO CO., LTD., Kawasaki-shi (JP)

(72) Inventors: Yuki Kokita, Kawasaki-shi (JP); Ryutaro Sugawara, Kawasaki-shi (JP)

(21) Appl. No.: 19/415,137

(22) Filed: Dec. 10, 2025

(30) Foreign Application Priority Data
Dec. 24, 2024 (JP) 2024-227183

(51) Int. Cl. C08F 8/40; C08F 112/08

(52) U.S. Cl. CPC C08F 8/40; C08F 112/08

(57) ABSTRACT

A composition exhibiting favorable base material selectivity, and which can form a polymer brush having favorable brush density and heat resistance, as well as a polymer. The composition is used in selective modification of a base material having a surface including two or more regions made of different materials. The composition contains a polymer and a solvent, in which the polymer has a constitutional unit derived from styrene and/or a constitutional unit derived from a styrene derivative, and the polymer has a group represented by Formula (1) below at a terminal of the main chain

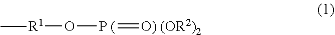

This application claims priority to Japanese Patent Application No. 2024-227183, filed Dec. 24, 2024, the entire content of which is incorporated herein by reference.

### BACKGROUND OF THE INVENTION

### Field of the Invention

The present invention relates to a composition for use in selective modification of a base material having a surface that includes two or more regions with different materials from each other, as well as a polymer.

### Related Art

Accompanying the further miniaturization of semiconductor devices, technology for forming fine patterns below 30 nm has been demanded. However, with conventional methods using lithography, the formation of finer patterns becomes technically difficult due to optical factors, etc.

Therefore, the development of technology for forming more finer patterns is being carried out by employing a phase-separated structure formed by self-assembly of a block copolymer in which blocks which are mutually immiscible bonded. For example, as a primer used in order to cause layers including block copolymers to phase separate and improve a substrate surface, Patent Document 1 proposes a primer containing a polymeric compound in which a first polymer block and a second polymer block bond via a linking group including a substrate adhering group.

In addition, a method has come to be considered for selectively modifying a base material having two or more fine regions having different materials from each other on a surface. In this selective modification method, a material which can simply and highly selectively modify a surface region is required, and thus various materials are being considered.
Patent Document 1: Japanese Unexamined Patent Application, Publication No. 2018-159061

### SUMMARY OF THE INVENTION

In the above-mentioned selective modification method, a polymer brush made using a polymer having an adsorptive terminal group is being developed. However, no primer exhibiting favorable base material selectivity, and which can form a polymer brush having favorable brush density is known yet.

In addition, after the above-mentioned selective modification, high-temperature treatment such as annealing may be performed upon self-assembly of the block copolymer, and thus a primer which can form a polymer brush with favorable heat resistance is also demanded.

The present invention has been made in view of the above-mentioned situation, and has an object of providing a composition exhibiting favorable base material selectivity, and which can form a polymer brush having favorable brush density and heat resistance, as well as a polymer.

In order to solve the above-mentioned problems, the present inventors conducted extensive research, a result of which it was found that using a composition containing a predetermined polymer (A) can solve the above-mentioned problems, thereby arriving at completion of the present invention. More specifically, the present invention provides the following.

A first aspect is a composition for use in selective modification of a base material having a surface including two or more regions with different materials from each other, the composition including:
a polymer (A); and a solvent(S), in which the polymer (A) includes a constitutional unit derived from styrene, and/or a constitutional unit derived from a styrene derivative,
the polymer (A) includes a group represented by Formula (1) below at a terminal of a main chain:

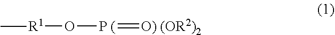

in Formula (1), R¹ is an optionally substituted divalent hydrocarbon group having 1 or more and 10 or less carbon atoms, and R² is a monovalent hydrocarbon group.

A second aspect is a polymer including a constitutional unit derived from styrene and/or a constitutional unit derived from a styrene derivative; and
a group represented by Formula (1) below at a terminal of a main chain:

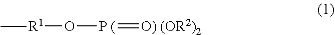

in Formula (1), R¹ is an optionally substituted divalent hydrocarbon group having 1 or more and 10 or less carbon atoms, and R² is a monovalent hydrocarbon group.

According to the present invention, it is possible to provide a composition exhibiting favorable base material selectivity, and which can form a polymer brush having favorable brush density and heat resistance, as well as a polymer.

### DETAILED DESCRIPTION OF THE INVENTION

Although embodiments of the present invention will be described in detail below, the present invention is not to be limited in any way to the following embodiments, and may be implemented by conducting modifications where appropriate within the scope of the purpose of the present invention.

### <<Composition>>

The composition can be used in selective modification of a base material having a surface including two or more regions having different materials from each other, and contains a polymer (A) and a solvent(S). The polymer (A) includes a constitutional units derived from styrene and/or a constitutional unit derived from a styrene derivative. The polymer (A) has a group represented by Formula (1) below as a terminal of the main chain.

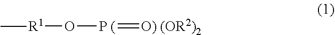

(In Formula (1), R¹ is an optionally substituted divalent hydrocarbon group having 1 or more and 10 or less carbon atoms, and R² is a monovalent hydrocarbon group.)

The surface of the base material preferably includes a region containing metal (hereinafter also referred to as “region (I)”), and more preferably includes a region consisting region (I) and substantially of only nonmetal (hereinafter also referred to as “region (II)”).

So long as the metal is a metallic element, it is not particularly limited. It should be noted that silicon is a nonmetal, and does not correspond to a metal. Examples of the metal include copper, iron, zinc, cobalt, aluminum, tin, tungsten, zirconium, titanium, tantalum, germanium, molybdenum, ruthenium, gold, silver, platinum, palladium, and nickel. Thereamong, copper, cobalt, tungsten, or tantalum is preferable.

Examples of the contained form of the metal in region (I) include elemental metals, alloys, conductive nitrides, metal oxides, and silicides.

Examples of the elemental metals include metal simple substances such as copper, iron, cobalt, tungsten, and tantalum. Examples of the alloys include nickel-copper alloys, cobalt-nickel alloys and gold-silver alloys. Examples of the conductive nitrides include tantalum nitride, titanium nitride, iron nitride, and aluminum nitride. Examples of the metal oxides include tantalum oxide, aluminum oxide, iron oxide, and copper oxide. Examples of silicides include iron silicide, and molybdenum silicide.

Thereamong, metal simple substances, alloys, conductive nitrides, or silicides are preferable, elemental alloys or conductive nitrides are more preferable, and copper simple substance, cobalt simple substance, tungsten simple substance, tantalum simple substance or tantalum nitride is even more preferable.

Examples of the contained form of the nonmetal in region (II) include nonmetallic elements, nonmetallic oxides, nonmetallic nitrides, and nonmetallic oxide nitrides.

Examples of the nonmetallic elements include the elements of silicon and carbon. Examples of the nonmetallic oxide include silicon oxide. Examples of the nonmetallic nitride include SiNₓ and Si₃N₄. Examples of the nonmetallic oxide nitride include SiON.

Thereamong, nonmetallic oxides or nonmetallic nitrides are preferable, and nonmetallic oxides are more preferable.

The existing shapes of region (I) and/or region (II) on the surface of the base material are not particularly limited and, for example, a plane shaped, dotted and striped shape in a plan view can be exemplified. The sizes of region (I) and region (II) are not particularly limited, and can be established as regions of the desired size as appropriate. The shape of the base material is not particularly limited, and can be set to a desired shape as appropriate, such as plate shaped (substrate) and spherical. The base material is preferably a substrate. The substrate may include a curved surface, and may include unevenness in this surface. The substrate is preferably a flat plate-shaped substrate having a smooth surface.

### <Polymer (A)>

Polymer (A) has a group represented by Formula (1) below as a terminal of the main chain.

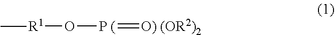

(In Formula (1), R¹ is an optionally substituted divalent hydrocarbon group having 1 or more and 10 or less carbon atoms, and R² is a monovalent hydrocarbon group.)

### (Group Represented by Formula (1))

Polymer (A) preferably has a group represented by Formula (1) only at one terminal of the main chain, from the viewpoint of the desired effect being easily obtained. In polymer (A), the number of groups represented by Formula (1) is preferably 1 or more and 3 or less, more preferably 1 or 2, and even more preferably 1.

The number of carbon atoms in the divalent hydrocarbon group as R¹ is preferably 1 or more and 8 or less, and more preferably 2 or more and 5 or less, from the viewpoint of brush density. The hydrocarbon group as R¹ is preferably an aliphatic hydrocarbon group, and more preferably an alkylene group. The alkylene group may be linear or may be branched; however, from the viewpoint of brush density, linear is preferable. Examples of the alkylene include a methylene group, ethane-1,2-diyl group, propane-1,2-diyl group, propane-1,3-diyl group, butane-1,4-diyl group, pentane-1,5-diyl group, hexane-1,6-diyl group, heptane-1,7-diyl group, and octane-1,8-diyl group. Thereamong, an ethane-1,2-diyl group or a propane-1,3-diyl group is preferable, and an ethane-1,2-diyl group is more preferable.

As substituents that the divalent hydrocarbon group of R¹ may have, carbonyl groups and ester groups can be exemplified. It should be noted that, in the present disclosure, the carbonyl group and ester group as the substituent is a group that replaces any methylene group (—CH₂—) constituting the above-mentioned hydrocarbon group. The divalent hydrocarbon group as R¹ preferably does not have a substituent from the viewpoint of brush density.

The monovalent hydrocarbon group as R² may be an aliphatic hydrocarbon group, may be an aromatic hydrocarbon group, or may be a group consisting of a combination of an aliphatic hydrocarbon group and an aromatic hydrocarbon group; however, it is preferably an aliphatic hydrocarbon group from the viewpoint of brush density. The carbon atom number of the aliphatic hydrocarbon group is preferably 1 or more and 10 or less, more preferably 1 or more and 5 or less, and even more preferably 2 or 3. An alkyl group is preferable as the aliphatic hydrocarbon group. The alkyl group may be linear or may be branched; however, it is preferably branched from the viewpoint of brush density. As the alkyl group, a methyl group, ethyl group, n-propyl group, isopropyl group, n-butyl group, isobutyl group, sec-butyl group, and tert-butyl group can be exemplified. The aromatic hydrocarbon group is a group consisting of only an aromatic hydrocarbon ring, or a group in which two or more aromatic hydrocarbon rings are bonded via a single bond. The aromatic hydrocarbon ring may be a single ring, or may be a condensed ring in which two or more rings are condensed. The carbon atom number of the aromatic hydrocarbon group is preferably 6 or more and 20 or less, and more preferably 6 or more and 12 or less. As the aromatic hydrocarbon group, a phenyl group, naphthyl group, anthryl group, phenanthryl group, and biphenyl group can be exemplified.

### (Constitutional Units)

The polymer (A) includes a constitutional unit derived from styrene and/or a constitutional unit (A1) derived from a styrene derivative.

As the styrene derivative, a compound in which a hydrogen atom bonded to the carbon atom at the x-position of styrene has been substituted by a substituent such as an alkyl group having 1 or more and 10 or less carbon atoms, a compound in which a hydrogen atom of the phenyl group of styrene has been substituted by a substituent such as an alkyl group having 1 or more and 10 or less carbon atoms, an alkoxy group having 1 or more and 10 or less carbon atoms, a hydroxy group, a nitro group, a halogen atom, an acetoxy group, or the like can be exemplified. As the styrene derivative, specifically, x-methylstyrene, 2-methylstyrene, 3-methylstyrene, 4-methylstyrene, 4-tert-butylstyrene, 4-n-octylstyrene, 2,4,6-trimethylstyrene, 4-methoxystyrene, 4-tert-butoxystyrene, 4-hydroxystyrene, 4-nitrostyrene, 3-nitrostyrene, 4-chlorostyrene, 4-fluorostyrene, 4-acetoxystyrene, 4-chloromethylstyrene, or the like can be exemplified.

Constitutional units represented by Formula (a1-1) below are preferably as the constitutional unit (A1).

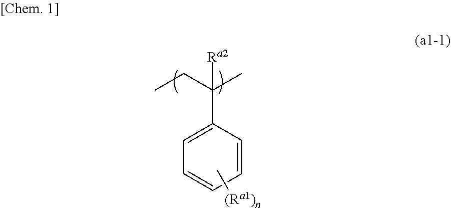

(In Formula (a1-1), R^{a1} is an alkyl group having 1 or more and 5 or less carbon atoms, n is an integer of 0 or more and 5 or less, and R^{a2} is a hydrogen atom or an alkyl group having 1 or more and 5 or less carbon atoms.)

The alkyl groups as R^{a1} and R^{a2} may be linear or may be branched. As the alkyl group, a methyl group, ethyl group, n-propyl group, isopropyl group, n-butyl group, isobutyl group, sec-butyl group, tert-butyl group, or the like can be exemplified.

n is preferably 0 or more and 3 or less, more preferably 0 or 1, and even more preferably 0.

The polymer (A) may have constitutional units other than the constitutional unit (A1); however, it preferably does not have constitutional units including a group represented by Formula (1).

The ratio of the mole number of constitutional units (A1) relative to the mole number of the total constitutional units constituting polymer (A) is preferably 50 mol % or more, more preferably 70 mol % or more, even more preferably 90% or more, particularly preferably 95 mol % or more, and may be 100 mol %.

(Structure represented by Formula (2-1) or Formula (2-2))

From the viewpoint of the desired effect being easily obtained, polymer (A) preferably has a structure (constitutional units and terminal structure) represented by Formula (2-1) below or Formula (2-2) below.

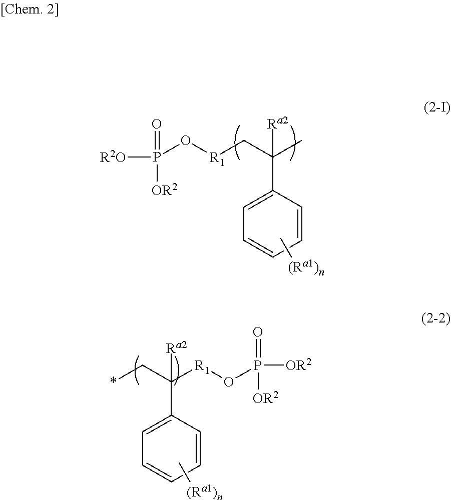

(In Formula (2-1) and Formula (2-2), R¹, R², R^{a1}, R^{a2} and n are the same as these groups in Formula (1) and Formula (a1-1)).

The number average molecular weight (Mn) of the polymer (A) is preferably 500 or more and 30,000 or less, more preferably 1,000 or more and 20,000 or less, and even more preferably 2,000 or more and 15,000 or less. If in the above-mentioned numerical range, a favorable brush density will tend to be obtained. In the present disclosure, “number average molecular weight” (Mn) is the number average molecular weight in terms of standard polystyrene obtained by size exclusion chromatography (SEC) measurement.

The production method of the polymer (A) is not particularly limited, and a conventional, known polymerization method can be employed. For example, polymer (A) can be obtained by a method including synthesizing a polymer having a group represented by —R¹—OH at a terminal of the main chain by polymerizing the monomer using a specific initiator and/or terminator, and causing a compound (terminal modifier) represented by X—P(═O)(OR²)₂ to react with this polymer. It should be noted that R¹ and R² are the same as these groups in Formula (1), and X is a halogen atom such as a chlorine atom.

### <Solvent(S)>

The composition contains the solvent(S). Organic solvents can be exemplified as the solvent(S). The organic solvent is sufficient so long as being an organic solvent which can dissolve each component used, and make a homogenous solution. Conventionally, any organic solvent selected from among known organic solvents as solvents of a composition with a resin as a main component can be used.

Examples of the organic solvent include lactones such as γ-butyrolactone; ketones such as acetone, methyl ethyl ketone, cyclohexanone, methyl-n-pentyl ketone, methyl isopentyl ketone and 2-heptanone; polyhydric alcohols such as ethylene glycol, diethylene glycol, propylene glycol and dipropylene glycol; monoacetates of polyhydric alcohols such as ethylene glycol monoacetate, diethylene glycol monoacetate, propylene glycol monoacetate and dipropylene glycol monoacetate; derivatives of polyhydric alcohols, for example, compounds having an ether bond such as monoalkyl ethers of the polyhydric alcohols, monoalkyl ethers of monoacetates of the polyhydric alcohols, monophenyl ethers of the polyhydric alcohols, and monophenyl ethers monoacetates of the polyhydric alcohols (Examples of monoalkyl ethers include monomethyl ether, monoethyl ether, monopropyl ether, and monobutyl ether, or the like) [among these, propylene glycol monomethyl ether acetate (PGMEA) and propylene glycol monomethyl ether (PGME) are preferred]; cyclic ethers such as dioxane; esters such as methyl lactate, ethyl lactate (EL), methyl acetate, ethyl acetate, butyl acetate, methyl pyruvate, ethyl pyruvate, methyl methoxypropionate, ethyl ethoxypropionate, and esters other than the derivatives of the foregoing polyhydric alcohols; and aromatic organic solvents such as anisole, ethylbenzyl ether, cresylmethyl ether, diphenyl ether, dibenzyl ether, phenetol, butylphenyl ether, ethylbenzene, diethylbenzene, pentylbenzene, isopropylbenzene, toluene, xylene, cymene, and mesitylene. The organic solvent component may be used alone or as a mixed solvent of two or more types. Among them, propylene glycol monomethyl ether acetate (PGMEA), propylene glycol monomethyl ether (PGME), cyclohexanone, or ethyl lactate (EL) is preferable.

The content of the solvent in the composition is appropriately set depending on the coating film thickness so that the concentration of the composition is such that it can be applied. The solvent is generally used so that the solid content concentration of the composition is in the range of 0.2% by mass or more and 70% by mass or less, and preferably 0.2% by mass or more and 50% by mass or less.

### <Other Components>

To the composition, if desired, compatible additives can further be added as appropriate, such as an additional resin for improving the performance of the underlayer film, a surfactant for improving the coating property, a dissolution inhibitor, a plasticizing agent, a stabilizing agent, a coloring agent, an antihalation agent, dyes, a radiosensitizing agent, a base-proliferating agent, and a basic compound, for example.

### <<Polymer>>

The polymer includes constitutional units derived from styrene, and/or constitutional units derived from a styrene derivative. The polymer includes a group represented by Formula (1) below at a terminal of the main chain.

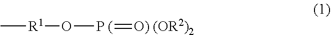

(In Formula (1), R¹ is an optionally substituted divalent hydrocarbon having 1 or more and 10 or less carbon atoms, and R² is a monovalent hydrocarbon group.

The details and preferred mode of the polymer are the same as polymer (A) in the aforementioned <<Composition>>.

As above, the following [1] to [6] are provided by the present inventors.

[1] In a composition for use in selective modification of a base material having a surface including two or more regions with different materials from each other, the composition includes:
a polymer (A); and a solvent(S), in which
the polymer (A) includes a constitutional unit derived from styrene, and/or a constitutional unit derived from a styrene derivative,
the polymer (A) includes a group represented by Formula (1) below at a terminal of a main chain:

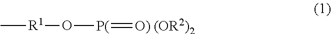

R¹ is an optionally substituted divalent hydrocarbon group having 1 or more and 10 or less carbon atoms, and R² is a monovalent hydrocarbon group.
   [2] In the composition as described in [1], the R¹ is a linear alkylene group having 1 or more and 10 or less carbon atoms.
   [3] In the composition as described in [1] or [2], the R² is an alkyl group.
   [4] In the composition as described in any one of [1] to [3], the polymer (A) does not include a constitutional unit including a group represented by the Formula (1).
   [5] In the composition as described in any one of [1] to [4], a number average molecular weight of the polymer (A) is 1,000 or more and 20,000 or less.
   [6] A polymer includes a constitutional unit derived from styrene and/or a constitutional unit derived from a styrene derivative; and
a group represented by Formula (1) below at a terminal of a main chain:

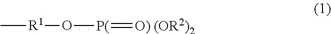

in which R¹ is an optionally substituted divalent hydrocarbon group having 1 or more and 10 or less carbon atoms, and R² is a monovalent hydrocarbon group.

### Examples

The present invention will be described in more detail below with reference to examples, but the present invention is not limited to these examples.

Hereinafter, polymers prepared using the Examples and Comparative Examples will be described.

### <Polymer>

A-1 to A-3: Polymers represented by below formula (A-1 number average molecular weight (Mn): 3,000; A-2 Mn: 5,000; A-3 Mn: 10,000).

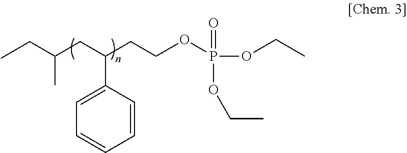

A-4: Polymer represented by below formula (Mn: 5,000)

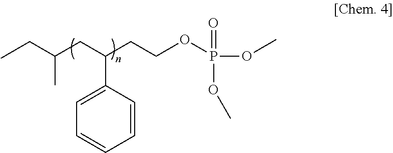

A-5: Polymer represented by below formula (Mn: 5,000)

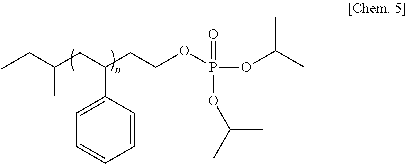

A-6: Polymer represented by below formula (Mn: 5,000)

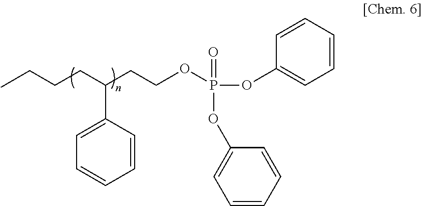

A-7: Polymer represented by below formula (Mn: 5,000)

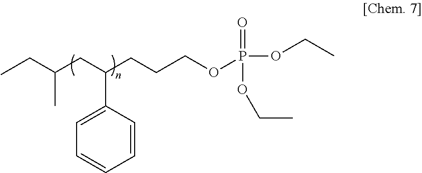

A-8: Polymer represented by below formula (Mn: 5,000)

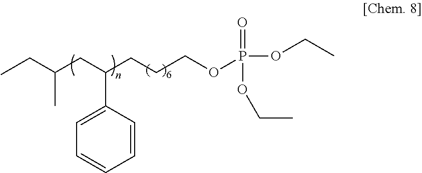

A-9: Polymer represented by below formula (Mn: 5,000)

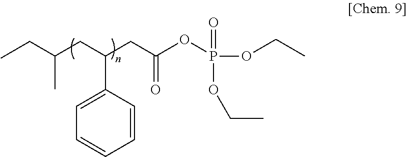

A-10: Polymer represented by below formula (Mn: 5,000)

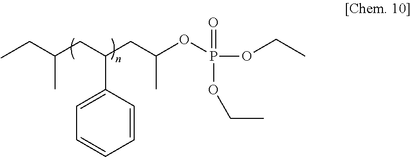

B-1 and B-2: Polymers represented by below formula (B-1 Mn: 10,000, B-2 Mn: 4,700)

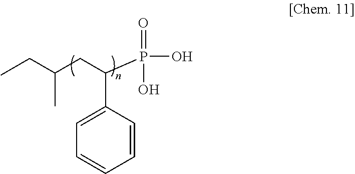

B-3: Polymer represented by below formula (Mn: 7, 900)

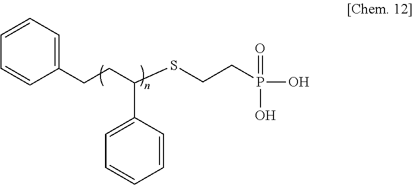

B-4: Polymer represented by below formula (Mn: 5,000)

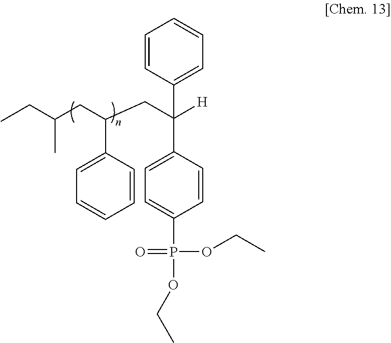

### <Synthesis of Polymer Precursor 1>

All anionic polymerization was performed under an argon atmosphere. An amount of 200 mL of tetrahydrofuran (THF) was transferred to a 300-mL Schlenk tube, and cooled to −78° C. in a Coolnics bath. To the Schlenk tube, sec-butyl lithium (sec-BuLi) (1.19 M hexane/cyclohexane solution) was added until the color of the solution turned yellow. The Schlenk tube was removed from the Coolnics bath, and warmed at room temperature until the solution turned colorless. The Schlenk tube was cooled to −78° C. in the Coolnics Bath again, and sec-BuLi (4.17 mL, 4.96 mmol) was added as an initiator. Styrene (27.4 mL, 0.238 mol) was added to the Schlenk tube, and stirred for 30 minutes. As a result, a bright orange-colored solution was obtained. Distilled (2-bromoethoxy) tert-butyldimethylsilane (5.46 mL, 24.6 mmol) was added as a terminator to the Schlenk tube to end polymerization. The Schlenk tube was pulled up from the Coolnics bath, and the solution was poured into methanol to carry out re-precipitation. After filtering the solid of the precipitate, reduced-pressure drying was performed at 40° C. to obtain a white powder. Next, the white powder and THE (10 wt % solution) was placed in a 300-mL glass tube, and tetrabutylammonium fluoride (TBAF) (12 mol equivalent/polymer end group) was added thereto. It was stirred overnight at room temperature to synthesize polymer precursor 1. A polymer precursor 1 solution was poured into methanol to perform re-precipitation. After filtering the solid of the precipitate, reduced-pressure drying was performed at 40° C. to obtain a white powder of polymer precursor 1. The Mn and degree of dispersion (PDI=Mw/Mn) of polymer precursor 1 measured by size exclusion chromatography (SEC) were respectively 5,000 and 1.04.

¹H NMR (400 MHz, CDCl₃, δ, ppm): 1.23-1.69 (br, backbone, —CH₂—CH—, PS, br, —CH₂—CH₂—OH), 1.74-2.02 (br, backbone, —CH₂—CH—, PS), 3.24-3.45 (br, —CH₂—CH₂—OH), 6.39-6.85 (m, o-aromatic, PS), 6.91-7.42 (m, m-, p-aromatic, PS).

### <Synthesis of Polymer Precursors 2 and 3>

Polymer precursor 2 and polymer precursor 3 were synthesized similarly to the synthesis of polymer precursor 1. The Mn and PDI of polymer precursor 2 were respectively 3,000 and 1.05, and the Mn and PDI of polymer precursor 3 were respectively 10,000 and 1.04.

### <Synthesis of Polymer Precursors 4 to 7>

Polymer precursor 4 to polymer precursor 7 were respectively synthesized similarly to the synthesis of polymer precursor 1, other than using (3-bromopropoxy) tert-butyldimethylsilane (case of polymer precursor 4), (8-bromooctoxy) tert-butyldimethylsilane (case of polymer precursor 5), tert-butyldimethylsilyl 2-bromoacetate (case of polymer precursor 6), or 2-[(tert-butyldimethylsilyl)oxy]propyl bromide (case of polymer precursor 7) in place of (2-bromoethoxy) tert-butyldimethylsilane as the terminator. The Mn and PDI of polymer precursor 4 to polymer precursor 7 were respectively 5,000 and 1.04.

### <Synthesis of Polymer A-2>

An amount of 5 g of polymer precursor 1 and dichloromethane (10 wt % solution) were placed in a 100-mL glass tube, and 4-dimethylaminopyridine (0.075 molar equivalents/polymer terminal group), triethylamine (3 molar equivalents/polymer terminal group), and diethyl chlorophosphate (3 molar equivalents/polymer terminal group) were added in order. This was stirred for 6 hours at room temperature to synthesize polymer A-2. The synthesized polymer A-2 was poured into methanol to perform re-precipitation. After filtering the solid of the precipitate, reduced-pressure drying was performed at 40° C. to obtain a white powder as polymer A-2. The Mn and degree of dispersion (PDI=Mw/Mn) of polymer A-2 measured by size exclusion chromatography (SEC) were respectively 5,000 and 1.04.

¹H NMR (400 MHz, CDCl₃, δ, ppm): 1.22-1.34 (br, —O—P(═O)(O—CH₂—CH₃)), 1.23-1.69 (br, backbone, —CH₂—CH—, PS, br, —CH₂—CH₂—O—), 1.74-2.02 (br, backbone, —CH₂—CH—, PS), 3.24-3.45 (br, —CH₂—CH₂—OH), 3.59-3.82 (br, —CH₂—CH₂—O—), 3.90-4.05 (br, —O—P(═O)(O—CH₂—CH₃)), 6.39-6.85 (m, o-aromatic, PS), 6.91-7.42 (m, m-, p-aromatic, PS).

### <Synthesis of Polymer A-1, Polymer A-3, and Polymer A-7 to Polymer A-10>

Polymer A-1, polymer A-3, and polymer A-7 to polymer A-10 were respectively synthesized similarly to the synthesis of polymer A-2, other than using polymer precursor 2 (case of polymer A-1), polymer precursor 3 (case of polymer A-3), polymer precursor 4 (case of polymer A-7), polymer precursor 5 (case of polymer A-8), polymer precursor 6 (case of polymer A-9) or polymer precursor 7 (case of polymer A-10), in place of the polymer precursor 1. The Mn and PDI of polymer A-1 were respectively 3,000 and 1.05, the Mn and PDI of polymer A-3 were respectively 10,000 and 1.04, and the Mn and PDI of polymer A-7 to polymer A-10 were respectively 5,000 and 1.04.

### <Synthesis of Polymer A-4 to Polymer A-6>

Polymer A-4 to Polymer A-6 were respectively synthesized similarly to polymer A-2, other than using dimethyl chlorophosphate (case of polymer A-4), diisopropyl chlorophosphate (case of polymer A-5), or diphenyl chlorophosphate (case of polymer A-6) in place of diethyl chlorophosphite as the terminal modifier. The Mn and PDI of polymer A-4 to polymer A-6 were respectively 5,000 and 1.04.

### <Preparation of Composition>

Polymers of the types listed in Table 1 were mixed with propylene glycol monomethyl ether acetate (PGMEA) so as to make a concentration of 1.0% by mass, thereby preparing the compositions of the respective examples.

### <Evaluation of Composition>

### (Surface Treatment of Substrate)

A tungsten (W) substrate was immersed in 0.2% by mass hydrofluoric acid, and rinsed with pure water, followed by drying with a nitrogen flow. A silicon oxide (SiO₂) substrate was subjected to surface treatment with isopropanol.

### (Formation of Film)

The compositions of the respective examples were coated by spin coating at 1500 rpm onto the surface treated tungsten substrate. The substrate coated with the composition was baked for 5 minutes at 200° C. using a hot plate in an air atmosphere. Thereafter, the substrate was rinsed with PGMEA to remove unreacted polymer. Furthermore, the substrate was baked for 1 minute at 100° C. to remove solvent, whereby a film was formed on the tungsten substrate. Similarly, a film was also formed on the silicon oxide substrate.

### (Evaluation of Contact Angle)

Using a Drop Master 700 (manufactured by Kyowa Interface Science Co., Ltd.), a pure water droplet (2.0 μL) was dropped to the surface of the substrate on which the film was formed, and the contact angle on the substrate was measured for 1 second each time for a total of 10 times. Measuring at 3 different points on the substrate, the average value for a total of 30 times was set as the contact angle of water. In addition, the contact angle of the substrate before forming a film was similarly measured as a reference example. The results are shown in Table 1.

### (Evaluation of Film Thickness)

The film thickness of the formed film was measured using a spectroscopic ellipsometer (M-2000 manufactured by J. A. Woollam). The results are shown in Table 1.

### (Evaluation of Brush Density)

Based on the film thickness of the tungsten substrate, the brush density of the film (polymer brush) formed on the tungsten substrate was calculated according to the following formula. The results are shown in Table 1. It should be noted that 1.05 g/cm³ (density of polystyrene) was used as the density of the polymer.

$$σ = d \times L \times NA \times {10}^{- 21} / Mn$$

(σ: brush density (chain number/nm²), d: density of polymer (g/cm³), L: film thickness (nm), NA: Avogadro's number, Mn: number average molecular weight of polymer (g/chain number))

### (Evaluation of Heat Resistance)

The tungsten substrate on which the film was formed was baked for 5 minutes at 280° C. by a hot plate in an air atmosphere. The baked substrate was rinsed with PGMEA, and then further baked for 1 minute at 100° C. For the substrate subjected to these treatments, the film thickness was measured and the brush density was calculated. Cases where the change was 5% or more relative to the brush density of the substrate prior to treatment were evaluated as “B”, and cases without 5% or more change were evaluated as “A”. The results are shown in Table 1.

TABLE 1

| | | | Water | | Film | | Brush | |
|---|---|---|---|---|---|---|---|---|
| | | | Contact | | Thickness | | Density | |
| | | | Angle (°) | | (nm) | | (chains/ | Heat |
| | | Polymer | W | SiO₂ | W | SiO₂ | nm²) | Resistance |
| Reference | | — | <10 | 45 | — | — | — | — |
| Example | | | | | | | | |
| Example | 1 | A-1 | 91 | 45 | 3.5 | 0.5 | 0.74 | A |
| | 2 | A-2 | 91 | 45 | 5.6 | 0.7 | 0.71 | A |
| | 3 | A-3 | 90 | 45 | 9.3 | 0.8 | 0.59 | A |
| | 4 | A-4 | 90 | 46 | 5.5 | 0.6 | 0.69 | A |
| | 5 | A-5 | 92 | 45 | 5.9 | 0.5 | 0.75 | A |
| | 6 | A-6 | 91 | 45 | 4.6 | 0.5 | 0.58 | A |
| | 7 | A-7 | 91 | 45 | 5.5 | 0.5 | 0.70 | A |
| | 8 | A-8 | 91 | 45 | 5.2 | 0.5 | 0.66 | A |
| | 9 | A-9 | 88 | 44 | 4.3 | 0.5 | 0.54 | A |
| | 10 | A-10 | 90 | 45 | 4.5 | 0.6 | 0.57 | A |
| Compar- | 1 | B-1 | 90 | 45 | 4.8 | 0.5 | 0.30 | B |
| ative | 2 | B-2 | 89 | 44 | 2.8 | 0.4 | 0.38 | B |
| Example | 3 | B-3 | 89 | 46 | 7.8 | 0.6 | 0.62 | B |
| | 4 | B-4 | 90 | 65 | 3.6 | 0.7 | 0.46 | B |

As shown in Table 1, in Examples 1 to 10 prepared using predetermined polymers, it was confirmed that the selectivity for the metal surface was favorable from the change in water contact angle relative to the reference example. In addition, it was confirmed that the film thickness of the formed film was thick and the brush density was high compared to Comparative Examples 1 to 4. Furthermore, it was also confirmed that the heat resistance was favorable.

What is claimed is:

1. A composition for use in selective modification of a base material having a surface including two or more regions with different materials from each other, the composition comprising:
a polymer (A); and a solvent(S),
wherein the polymer (A) comprises a constitutional unit derived from styrene, and/or a constitutional unit derived from a styrene derivative,
wherein the polymer (A) comprises a group represented by Formula (1) below at a terminal of a main chain: 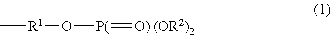
wherein R¹ is an optionally substituted divalent hydrocarbon group having 1 or more and 10 or less carbon atoms, and R² is a monovalent hydrocarbon group.

2. The composition according to claim 1, wherein R¹ is a linear alkylene group having 1 or more and 10 or less carbon atoms.

3. The composition according to claim 1, wherein R² is an alkyl group.

4. The composition according to claim 1, wherein the polymer (A) does not include a constitutional unit comprising a group represented by the Formula (1).

5. The composition according to claim 1, wherein a number average molecular weight of the polymer (A) is 1,000 or more and 20,000 or less.

6. A polymer comprising a constitutional unit derived from styrene and/or a constitutional unit derived from a styrene derivative; and
a group represented by Formula (1) below at a terminal of a main chain: 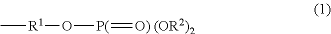
wherein R¹ is an optionally substituted divalent hydrocarbon group having 1 or more and 10 or less carbon atoms, and R² is a monovalent hydrocarbon group.
